(19) United States
(12) Patent Application Publication
(10) Pub. No.: US 2012/0028682 A1
(43) Pub. Date: Feb. 2, 2012

(54) Steering wheel attached cellular phone interface device for communication with alert system

(76) Inventor: Chris Danne, Naugatuck, CT (US)

(21) Appl. No.: 13/136,321

(22) Filed: Jul. 28, 2011

Related U.S. Application Data
(60) Provisional application No. 61/368,837, filed on Jul. 29, 2010.
(60) Provisional application No. 61/379,069, filed on Sep. 1, 2010.
(60) Provisional application No. 61/476,881, filed on Apr. 19, 2011.

(51) Int. Cl. H04W 88/02

(52) U.S. Cl. 455/557

(57) ABSTRACT

A cell phone communications device for use with an automotive steering wheel including; a screen attached to a steering wheel. The screen includes a first visual alert device such as a message and flashing arrow. A first hand unit attached to the steering wheel adjacent the left hand of the user at the 10 O'clock position and a second hand unit adjacent the right hand of said user. The first hand unit includes a communications control keyboard for texting and a second vibration alert device. The second hand unit includes a second communications control keyboard for texting and a third alert device. When the user is driving and communicating the user receives a visual alert from the first alert on a regular basis during scrolling, reading and composing text functions. When the first alert is triggered during reading the user also receives a regular second and third alert vibration; during composition the user receives the second and third alert every other time and during reading the second and third. Thus the second and third alerts become associated with the first alert and in this way the driver is trained to look up at the road.

### CROSS-REFERENCE TO RELATED APPLICATIONS

Application numbers: Applicant claims priority under 35 USC 119 to provisional patent applications 61/368,837 filed Jul. 29, 2010; 61/379,069 filed Sep. 1, 2010 and 61/476,881 filed April 2011 to the same inventor.

### FEDERALLY SPONSORED RESEARCH

Not Applicable

### SEQUENCE LISTING OR PROGRAM

Not Applicable

### BACKGROUND

1. Field

This application relates to cellular phones, specifically, accessories or applications which make texting while driving safer.

2. Prior Art

Several approaches have been taken in making hands-free communications work safely in driving situations. These approaches have taken similar paths and, therefore, have similar problems. For instance, U.S. patent application 2002/0068605 to Stanley (2002) has a poor location for a viewing screen which is located in the steering wheel center. This requires the driver to look completely away from the road to see the screen. Similarly, U.S. patent application 20090005125 to Venhofen and Jung (2009), U.S. Pat. No. 5,319,803 to Allen (1994) all have screens that cause the driver to look down.

U.S. Pat. No. 7,756,550 to Piekarz (2010) has a screen that can be moved in the car, but the screen is so bulky and tall that it can block a large part of the driver's view of the road. Other attempts to make a drive safe way of viewing information is U.S. Pat. No. 7,450,961 to Heubel and Clegg (2008) using a projection device. At first, this seems to solve the problem of blocking the

driver's view due to looking through a translucent image. However, varying degrees of light can interfere with or obscure any projection, especially when projected on to a windshield on sunny days.

Some devices are inconveniencing as far as having to replace a steering wheel or steering column in order to install such as 20020068605 to Stanley (2002) and U.S. Pat. No. 5,319,803 to Allen (1994). U.S. Pat. No. 6,731,925 to Naboulsi (2004) takes a completely different direction in addressing safety and distraction as it pertains to cellular phones. This device has an intricate network of sensors located in and around the outside of a vehicle. These sensors attempt to detect and preempt dangerous situations but can be fooled by false positives like a squirrel moving. As can be seen there is a need for improved safety regarding communication while driving a vehicle.

### SUMMARY

A cell phone communications device for use with an automotive steering wheel including;

a screen attached to a steering wheel. The screen including a first visual alert device such as a message or flashing arrow. A first hand unit attached to the steering wheel adjacent the left hand of the user at the 10 O'clock position and a second hand unit adjacent the right hand of said user at 2 O'clock. The first hand unit includes a communications control keyboard for texting and a second vibration alert device. The second hand unit includes a second communications control keyboard for texting and a third alert device. When the user is driving and communicating the user receives a visual alert from the first alert on a regular basis and an alert from said second and third alerts on a variable, irregular and/or random basis.

Vibration acts as a sensory alert and audio alert with the “buzzing” of the motors. The nature of having alerts go off in regular intervals is reinforcing in and of itself. Between the message, light, vibration and buzzing these alerts are considered multi-model which make for the most effective warning systems. Vibration alert reinforce other alerts through pairing. Allowing for the

same reaction in the absence of the vibration/buzzing.

To combat cognitive distractions of messages, this embodiment trains the user to look up in three second intervals. When the lights are paired with the vibrations and warning message on the second alert, the mind associates them. So when the lights blink on the first warning message, the same, yet, more urgent response of the second alert is given without the vibration. This association/conditioning may happen in a short period of time. The benefit of this is that it makes the vibration warning less cumbersome to the user, but with the same effect. No one would want a device that was constantly buzzing them.

It would be too irritating and would cause the user to be desensitized to the alerts' impact over time. Robert Gray, who has spent 15 years studying driving distractions, indicated that auditory and visual warnings are usually inefficient in comparison to tactile or physical warnings. He is currently improving on vibrating technology in vehicles that warn drivers of potential rear-end collisions.

Essentially, the embodiment trains the driver to be a more responsible “texter” while driving. Visual distractions caused by viewing the display screen are minimized by the various alert systems. The key orientation stud allows the user to find and memorize keys without looking and the blue electric light warns when the driver should look down at the screen for new incoming messages or ones that have been missed and scrolled off the screen. By dividing the visual field into two separate areas (screen and road), the driver can give full attention to one or another instead of creating a mix of visual and cognitive stimuli that occur

with Bluetooth-type and vocal communication devices. The alerts simply tell the driver when it is time to switch from one visual field to the other. As much time is spent looking away from the road when someone is eating, using a GPS,
adjusting the stereo, etc.

Since the display screen is positioned on the top of the steering wheel rim, it is easy to look up an inch to see the road as opposed to six inches to a foot for normal texting. Texting while driving is typically done with the cellular phone on the lap of the driver or on the bottom of the steering wheel. The positioning of the display screen increases reaction time in comparison to normal texting. The embodiment produces no auditory noise/distractions. Physical distractions are also minimized by the hand units. They keep the driver's hands fixed at the ten and two o'clock positions on the steering wheel. Keypads are easily viewable as they are in front of the driver close to windshield level. This may improve lane maintenance (staying in your lane on the road) which studies suggest to be the major danger of texting while driving. The driver can fully turn the wheel without obstruction while hand and display screen units are attached.

### DRAWINGS—FIGURES

FIG. 1 shows inside car view,

FIG. 2 shows steering wheel front view,

FIG. 3 shows the steering wheel back view,

FIG. 4 shows a close up view of a hand unit,

FIG. 5 shows a back view of a hand unit,

FIG. 6C shows front view left handgrip unit,

FIG. 6D shows and alternate embodiment of the right hand grip unit,

FIG. 7A shows a close up view of the display screen,

FIG. 7B shows a back view of the display screen,

FIG. 7C shows a side view of the display screen,

FIG. 8A shows a view of the charger,

FIG. 8B shows the charger folded up,

FIG. 8C shows the cable detail,

FIG. 9 shows the unit assembled for transport,

FIG. 10 shows a flowchart of the method.

### DESCRIPTION

Dealing with distraction is the key to the effectiveness of any communication technology used while driving a car or operating any vehicle. More specifically with texting, we must consider the behaviors that make texting while driving dangerous. First, a texting driver does not keep both hands on the wheel. Second, the texting driver looks too far down away from the road in order to text. Lastly, the texting driver looks up at the road sporadically. This device 1 forces the driver to have both hands on the wheel at the 2 and 10 o'clock positions in order to text, the display screen unit 14 keeps the driver's eyes level with the road 22a and the alert systems both warn and train the driver to look up in consistent 3 second intervals. This embodiment satisfies the texting behavior while minimizing distraction. The device also works to train reduced distraction during other non-driving activities in the car.

Removing all distractions during driving is impossible (i.e. radio, gps, drinking a beverage, eating, talking etc.). All anyone can do is reduce the distractions, not eliminate them. This embodiment uses alert systems that warn and train the user to know how much time is too much when not looking at or concentrating on the road through a combination of vibration, message and light alerts. It simultaneously warns and trains the driver through conditioning in order to minimize driver distraction. One of the main advantages of conditioning is the more one engages in a behavior to be shaped the faster one becomes conditioned to the desired one. In other words, the more someone texts or talks when driving, the faster they may be trained to look up in set and regular intervals by the device.

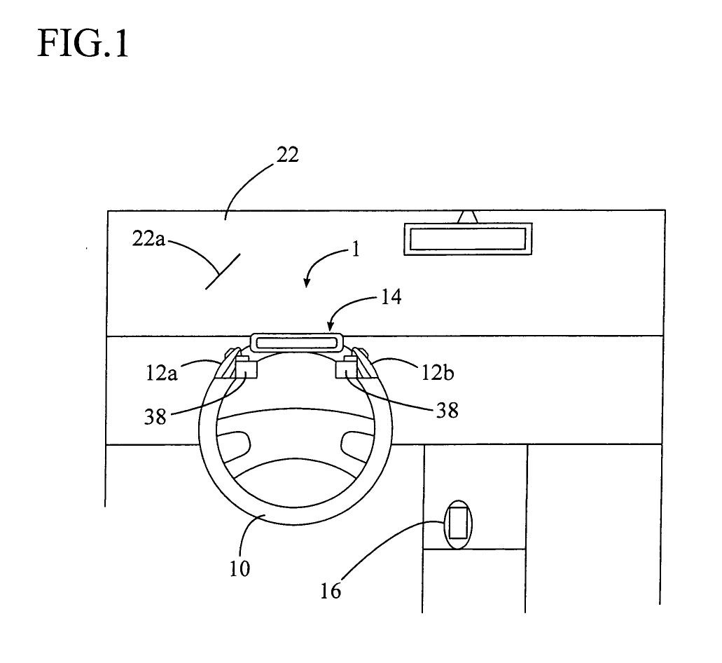

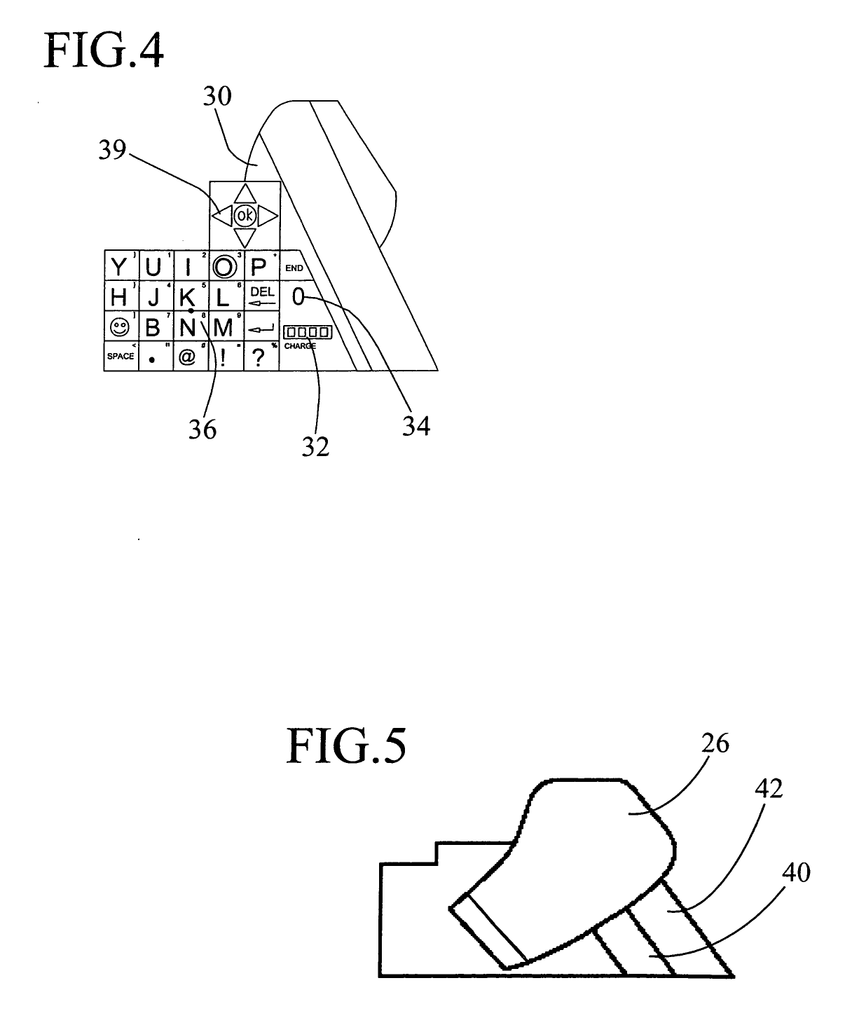

Referring to FIG. 1, the system 1 consists of two handgrip units 12a and 12b with attached communication controls such as keypads 38a, 38b and a vehicle steering device such as a car steering wheel 10 and mounted display screen unit 14. The keypads 38a, 38b on each handgrip unit 12a, 12b face inwards towards the center of the steering wheel 10 (see FIGS. 1, 2 and 4). The handunits 12a, 12b can be composed of a medium to high durometer urethane plastic for example. The alpha-numeric keypads 38a, 38b configuration, number and individual key sizes are consistent with those of most slide-type cellular phones with landscape/horizontal keypads only divided into two pieces for each keypad so that all the buttons 13 on a keypad 38a, 38b can be reached by the user's thumbs without removing their hands from the steering wheel 10. Combined the two keyboards 38a, 38b contain the full alphabet. A key orientation stud 36 (FIG. 4) is located on each keypad 38a, 38b. The section of keys that have numbers on them can be shaded a different color from the rest of the key buttons 13. The system 1 communicates with a communication device such as a text enabled phone 16 and can do so wirelessly. The screen 14 can be attached anywhere in the vehicle but ideally is at the top of the steering wheel 10 and is adjacent or within the field of view that includes the windshield 22 such that a driver can look at the screen 14 and the road 22a within a single field of view. Shifting between the road 22a and screen 14 is just a matter of shifting mental focus. The screen 14 can include a computer controller. The communications control is shown as a keyboard but could be any device that aids in communication such as a telephone or microphone or microphone control to monitor conversation in the cabin of the vehicle, or an eye tracking unit to monitor where the driver is looking during conversation for example.

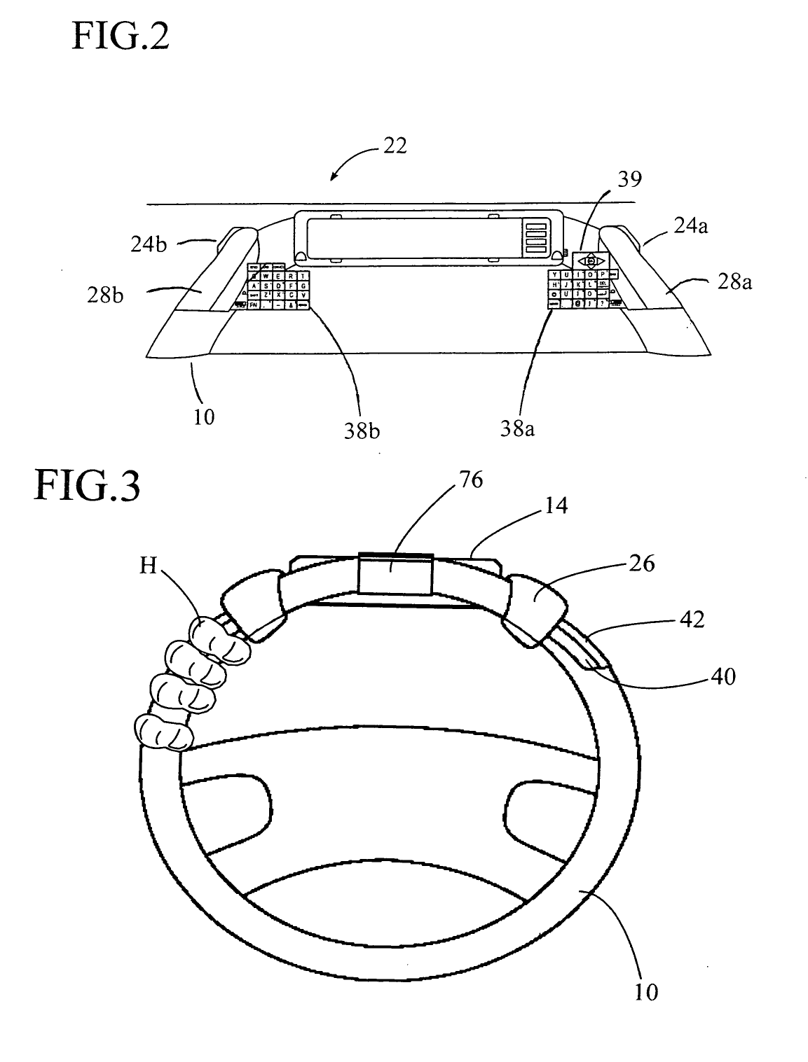

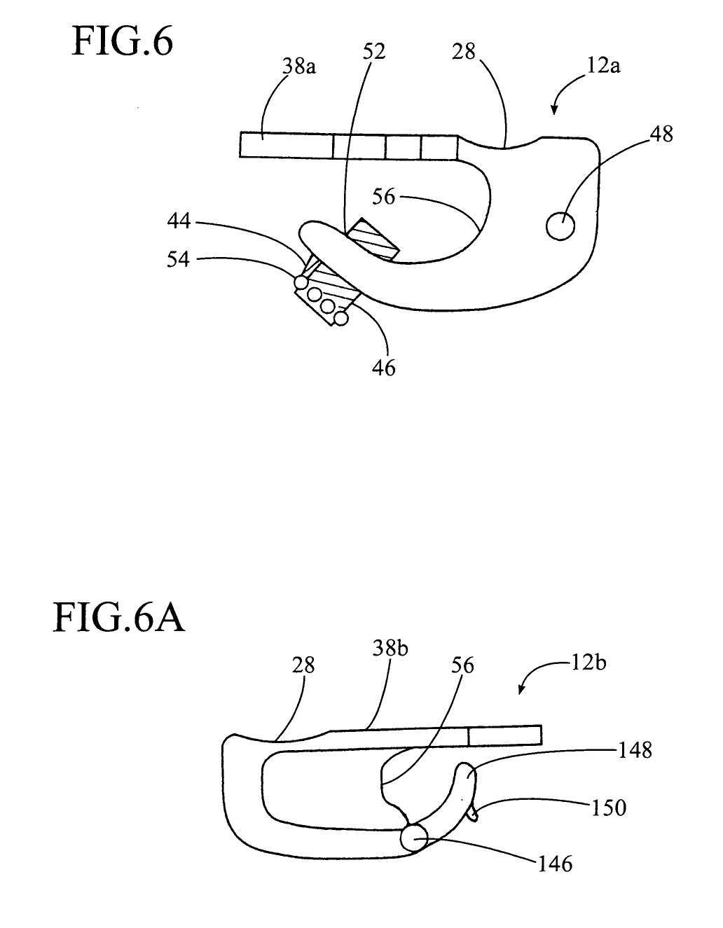

Referring to FIG. 2, the scroll button 39 on the right keypad 38a has a tactile point of reference such as a slightly raised outline to its frame to allow for easier directional scrolling. The OK button in the center of 39 is raised as well except for the surrounding inside area. The hand units 12 attach to the sides of the steering wheel 10 rim at the ten and two o'clock positions adjacent to but spaced from the screen 14. As shown in FIG. 4 each hand unit 12 has a night safe light button 34 and battery charge indicator 32 under it located at the far left and right of each keypad between a piece of the hand unit frame 30 and keypad 38. It is a small rectangular electric light bar separated into four evenly spaced increments. The tops of the hand units 12 have a thumb rest 24 and thumb canal 28 on either side running down the front diagonal sides of the frame of each hand unit (see FIGS. 2, 6 and 6A). The left thumb canal 28a and rest points diagonally up and to the right. The right thumb canal 28b and rest points diagonally up and to the left.

FIG. 3 shows the back of steering wheel 10. The screen 14 includes a grip portion 76 attached the wheel 10. The hand units 12a and 12b include grip portions 40, 42 that allow a driver's hand H to grip the steering wheel 10 and the grip portion 40, 42 at the same time to assure a firm grip on the steering wheel 10.

Vibration mechanism housings 26 (FIG. 5) are located on the left and right of the outer edges of the hand units 12 adjacent to thumb rests 24. They wrap around the back of the hand units 12a, 12b to create the steering wheel clip (see FIGS. 6 and 6A). Inside each housing 26 is a small vibration motor which is surrounded on the sides and bottom by a low to medium durometer elastomer. This elastomer acts as a buffer between the motor itself and the inside frame of the housings 26.

Centered on the top of each hand unit 12a,b is a USB charger port 48 (see FIG. 6). Steering wheel 10 rim canals 56 are curved horizontally in a semi-circle shape to fit at the two and ten o'clock positions on a steering wheel 10. The flexible urethane plastic around the rim canal allows for a better fit on thicker steering wheel rims. The steering wheel rim canals 56 are also covered with a thin layer of a high durometer elastimer which have studs 50 made from the same material arranged in diagonally intersecting rows. The tightening screw 46 is composed of a medium to high durometer urethane.

The hand units clips have attachment means such as tightening screws 46. The tightening screws 46 are

located on the bottom center of the clips of each hand unit. The tops of each screw 46 have a circular line of evenly spaced curved spokes 54 surrounding it. They penetrate the frame of the clip through a screw shaft 52 with groves. A pawl 44 or hinged catch on the top surface of the clip keeps the screw 46 from loosening by keeping the spokes 54 on it fixed into position. The pawl 44 is made of a medium to high durometer elastimer. FIG. 6A shows an alternate attachment means which is a quick clamp 146. The quick clamp 146 includes a spring loaded lever arm 148 to grip the steering wheel 10 and a quick release trigger 150 which allows the user to remove the unit 12b by pulling trigger 150.

The outer sides of the hand units 12 have finger slots 42 with finger groves 40 below them (see FIG. 5). The finger slots 42 are an open space allowing the driver's fingers to hold onto the hand units 12 and steering wheel 10 simultaneously. They are located on the back bottom part of the frame below the finger grooves. The finger grooves 40 are thin and slanted downward. They are made of a low durometer urethane running along the top inside frame of the finger slots. The hand units can be of any color.

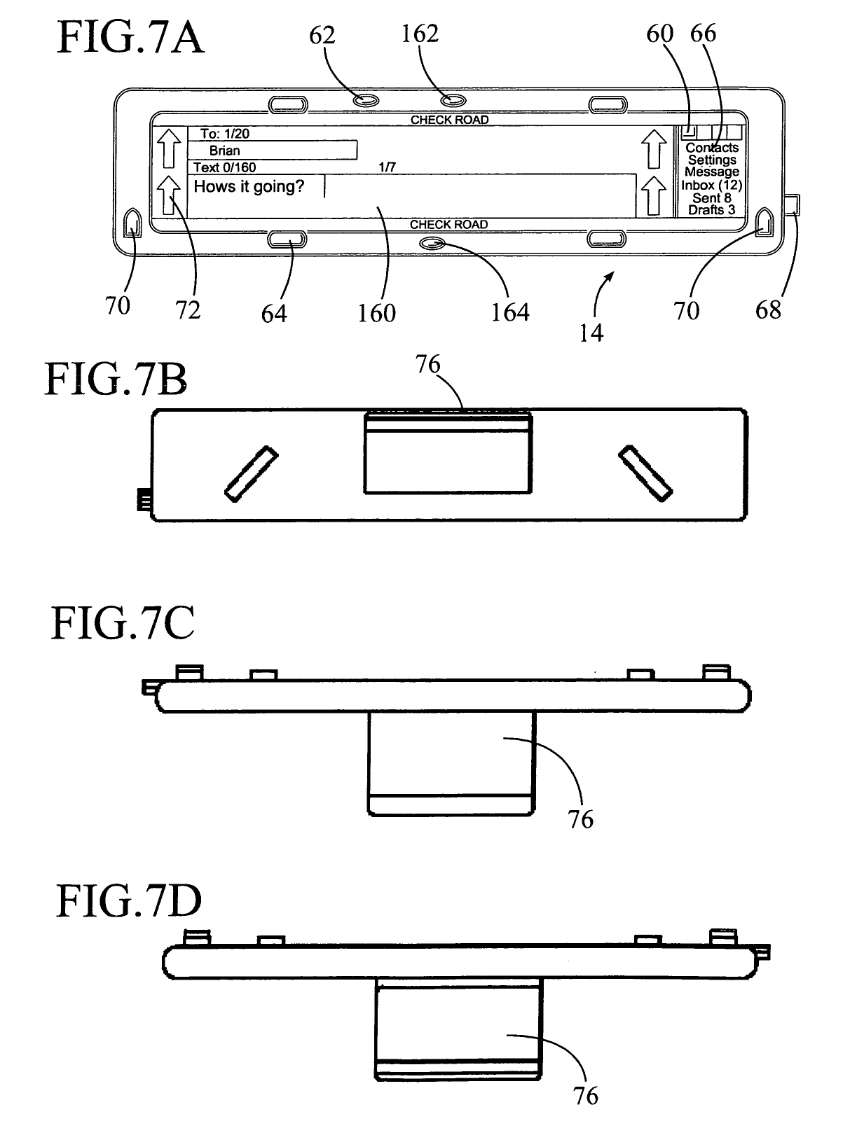

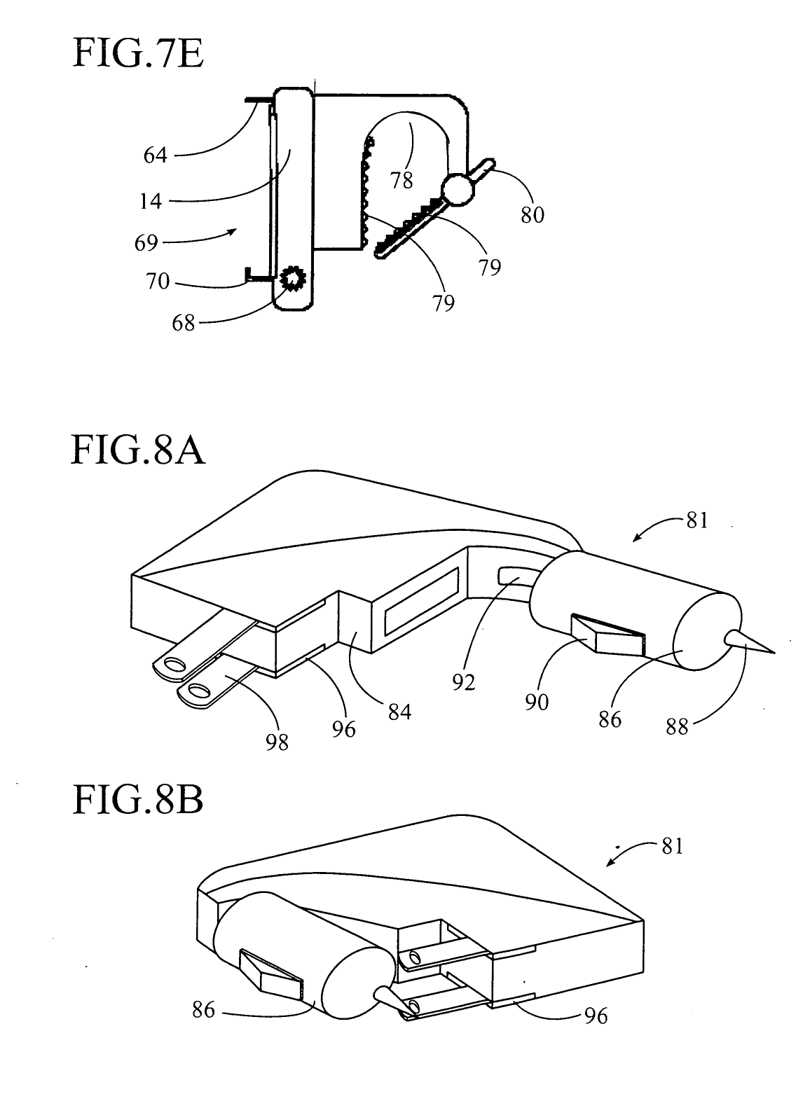

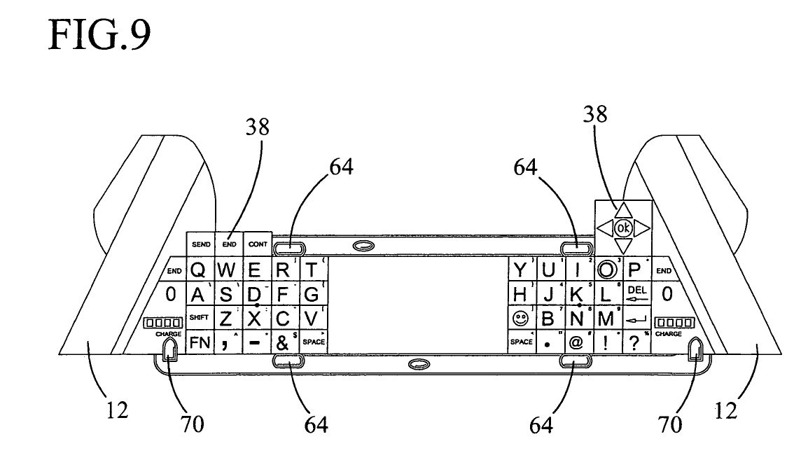

The display screen unit 14 (see FIGS. 7A and 7B) is a rounded rectangular shape and can have a slant adjustment with clamp 80. It is made of a medium to high durometer urethane. The display unit 14 can be shaded a dark color so that the unit's electric lights are accentuated against a dark background. The display screen face 160 has yellow electric lights 62 on the top and bottom of the screen's frame (see FIGS. 2, 7A and 7B) or on the screen 160. On the top there is yellow electric lights 62. Two yellow electric warning arrows 72 are located on either side of the frame of the display unit's face 160. The display screen is also a privacy screen/filter 74 similar to those on laptops which hide the screen's contents from the view of others. The display unit 14 has an illumination control dial 68 located at the bottom right side of the display screen unit (see FIG. 7A). Turning it away from the user brightens the screen and turning it toward the user darkens it. On the bottom left side of the display screen unit is a USB charger port 82. Just above the bottom light bar and just below the top light bars are keypad guards 64. They are small rectangular protrusions which width are equal to the thickness of the keypads 38, the keyguards 64 function to hold the keypads 38 in place when the unit 1 is assembled for portability (See FIG. 9). At the bottom of each bottom arrow are keypad holders 70. They are also protrusions about the width of the keypads with half oval parts pointing up at their front edges. The display screen 14 can include messages 60 in a message center 66 such as an indication that text messages are waiting to be read.

FIGS. 7B, C, and D show the steering wheel grip 76 is a rectangular box coming out of the back of the displays screen unit 14. It has a hallowed flat surface that leads to a curved cavity in the center. Within the cavity is a slightly curved area on its top inside surface best seen in FIG. 7E. The wheel grip 76 includes a quick release clamp 80 best seen in FIG. 7E. The unit 1 can include provisions for voice communication. The display 14 can include a microphone 162 and speaker 164. As seen in FIG. 7E the wheel grip 76 includes a quick clamp 80 that can clamp the steering wheel 10 into the clip slot 78. Grippers 79 prevent the wheel grip 76 from slipping, many modern steering wheels have a soft gripping surface that the grippers can deform and bite into without damaging the steering wheel. FIG. 7E shows a profile view of the slot 69 created between the keypad guard 64 and the keypad holder 70, the slot 69 holds the keypads 38 in the portable configuration shown in FIG. 9.

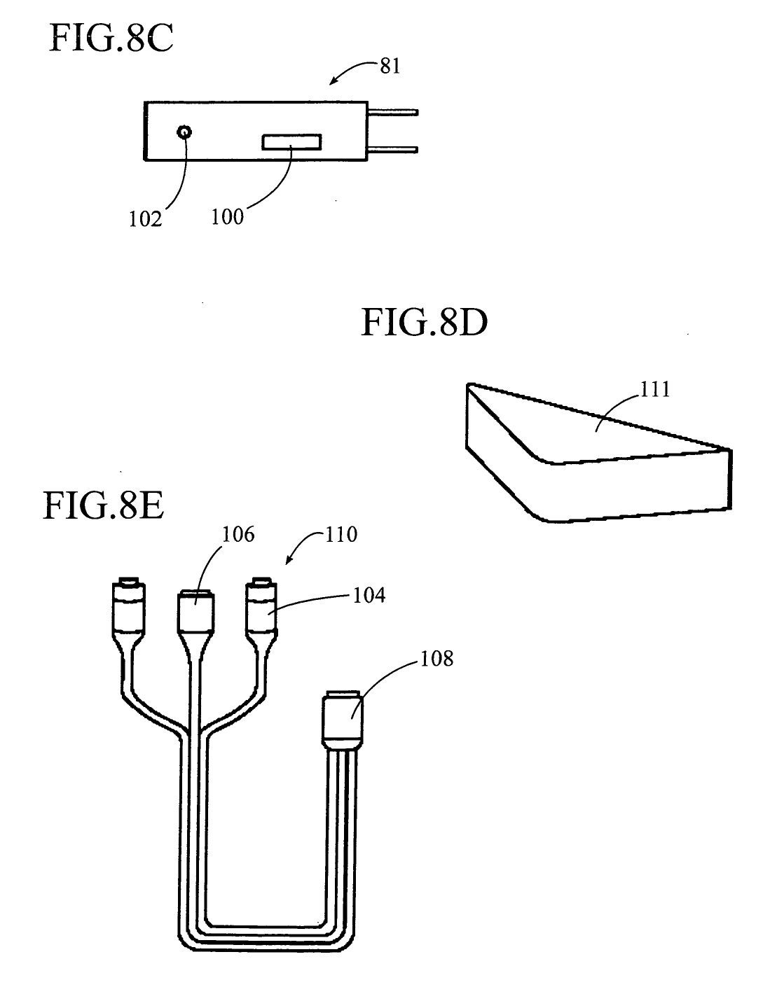

FIGS. 8A and 8B show the embodiment also comes with a battery charger unit 81 for the display screen 14 and two hand units 12. The battery charger 81 consists of a converter box 84 with folding blades 98 of an outlet plug at the back of it.

Blade canals 96 line up with the corresponding blades running along the sides of the plug. The USB cable 110 (FIG. 8E) has three plugs at one end. Two hand unit plugs 104 and one display screen unit plug 106. The two hand unit plugs 104 have cylindrical body with metallic tips which are hollow with contact teeth inside. The display screen unit plug 106 has a rectangular body with metallic tips which are hollow with contact teeth inside. At the other end of the cable 110 is a USB charger plug 108. A small rectangular piece with metallic tips hollow with contact teeth inside. On the side of the converter box 84 is a DC plug 86 which has an elongated cylindrical-type body.

Attached to the plug's top is a tip connector 88 which is metallic and bullet shaped. Half way down on either side of the DC plug 86 are side ground contacts 90. They are two edge shaped metallic prongs which are spring loaded and retract into their slots as they are pressured. The lever canal 92 allows the DC plug to fold down. One of the side ground contact fits flush into the ground contact canal 94 in front of it. On the other side of the converter box are a power LED light 102 and a USB charger port 100 (FIG. 8C). The LED light 102 is a small circular green electric light. The USB charger port 100 is a small rectangular slot

across from it. There is also a side case 111 shaped like half of the converter box (see FIG. 8D), the side cover covers the power plug 86 and contact 90 in the folded position shown in FIG. 8B. The charger's converter box and cover is made from a medium to high durometer urethane. The charger can be any color. Although shown with a charger the device would also work with solar power such as having a solar cell on the back of the screen 14 and/or the hand units 12a, b.

FIG. 9 shows the device system 1 removed from the steering wheel 10 and assembled in a portable configuration. The hand units 12a and 12b are removed from the steering wheel 10 and attached to the screen 14. The device 1 can be used in this configuration but in most cases portability allows a user to prevent theft and allows a user to move the device from one vehicle to the next. In an alternate embodiment not shown, the hand units 12a and 12b could be inserted into slots in the screen.

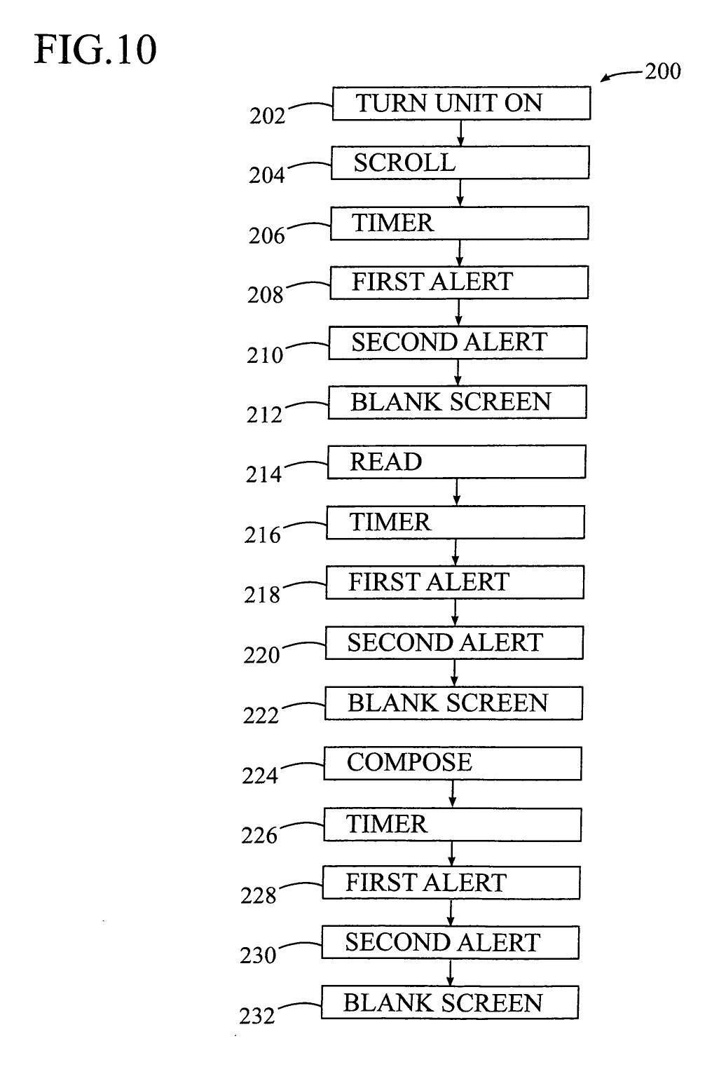

FIG. 10 shows text example steps of the method of alerting 200 a driver engaged in communication. The first step is to turn the device 1 on 202 which powers the screen 14 and hand units 12a, b. A user could scroll through, 204, read 214 or compose 224 text messages in any order. Scrolling, reading and composing are shown in a first order but they can occur in any order. Typically a user would scroll 204 through messages first and then read 214 or compose 224. During scrolling 204 a timer starts 206, and the first alert 208 begins with scrolling 204. In this case the first alert can be a visual display of flashing lights and warning messages on screen 14. After 1.5 seconds the second alert 210, which is vibration in each hand unit 12, starts on a random basis. After a total time of 3 seconds the screen 14 becomes blank 212. Another text function is to read 214. The start of reading triggers a timer 216 and first alert. In this case the first alert can be a visual display of flashing lights and warning messages on screen 14. After 1.5 seconds the second alert 220 will start on a regular schedule such as every time and will vibrate for 1.5 seconds then the screen will blank 222 until a key is hit. A third text option is to compose 224. Again starting composing a text message also starts the timer 226 and first alert 228. After 1.5 seconds the second alert starts on a partial schedule such as every other time or every third time and if it starts vibrates for 1.5 seconds until the screen blanks 232. Each text operation 204, 214 and 224 include a different variation of the alert. The specific alert schedule associated with any one text operation is not critical and they could be interchanged.

What is critical is that the alert schedule varies to enhance training of the driver by pairing the first visual alert with the second alert. Variable reinforcement is more effective than a constant reinforcement.

### Operation

The display screen unit 14 remotely relays messages to and from the cellular phone's 16 voice and texting program as entered through the keypads 38 on the hand units 12a, b and microphone 162 and speaker 164 and receives messages through the cellular phone 16. The embodiment can control a cellular phones texting program but can also include voice. The embodiment can connect to a smart phone and/or non-smart phone through the phone's Bluetooth application or through other operating systems like ANDROID or BLACKBERRY for example. Pressing any key button 13 on the keypad 38 activates the device. Pressing any button on the keypads 38 turns the display on. The Bluetooth application in settings activates the interface between the device and a cell phone's texting program. There can also be voice activated GPS and BLUETOOTH talk and speech to text applications. On top of the menu is a battery charge graphic depicting the display screen unit's charge levels in four increments. As seen in FIG. 11, the menu has the following options: CONTACTS, SETTINGS, NEW MESSAGES, INBOX, SENT, and DRAFTS. All emails and calls are sent to mailboxes while the device 1 is on. Video and image texts cannot be viewed on the display screen 14 and are automatically sent to the text inbox. This embodiment uses alert systems to warn drivers to watch the road.

The first texting alert system is the scrolling alert. Going to any screen or menu that is not a reading or composing screen is considered scrolling and picks up where other types of alerts leave off. Scrolling within a message does not conform to

the scrolling alert but the appropriate alert for the screen whether reading or composing. This alert activates every 3 seconds beginning with an alert message to observe the road (something like “CHECK ROAD”) flashing across the entire screen 160 while the electric warning lights and arrows 72 on the display screen 160 blink in an upwards fashion (See FIG. 11). The bottom light bar blinks first then the bottom most arrows on the screen sides, then the top arrows and lastly the light bars at the top of the screen in succession. The first 1.5 seconds of the alert starts with vibrations at random. The alert message flashes once between 0.10 and 0.75 seconds long for all types of alerts. Individual light sequences blink in 0.25 second intervals for all types of alerts. The lights continue to blink for 3 seconds. Unless a key button 13 is pushed, this alert timing cycles three times then the screen 160 blanks out, otherwise, it remains active until the user enters a composition or reading screen. Alerts remain inactive during screen blank outs. The user can still scroll and change screens during the scrolling alert. Timings for scrolling alerts pick up where other types of alerts leave off. Alerts (lights, message and/or vibration) may have variable durations.

The second texting alert is the composition alert which begins when the driver starts typing in a composition screen. After 3 seconds the alert begins with the above mentioned alert message ‘check road’ flashing once with the lights and arrows 72 blinking upward for 3 seconds and ends by the screen blanking out. Pressing any button 13 gets the user back to the screen. 3 seconds after the driver begins typing again the next alert begins with the alert message flashing, upward blinking lights and arrows continue for 3 seconds with the screen 160 blanking out at the end.

Vibrations start the alert for the first 1.5 seconds. The alerts with vibrations occur on every other cycle. If the keypad 38 does not sense typing after 3 seconds of entering the screen, the screen blanks out with no additional alerts. The scrolling alert timing picks up where the composition alert left off until a selection is made which then brings the driver back to the main screen. When a message is sent or saved during an alert pause or a just a light alert, the screen returns to the main menu and the scrolling alert timings pick up where the composition message left off. Composition messages have the following options on the

bottom of the screen: SAVE and SEND. Selecting SAVE during a light alert or pause has the scrolling alert pick up where the composition alert timing leaves off: The SEND label is always at the center bottom of the screen. If the user
does not type anything in 3 seconds after opening the composition screen the screen blanks out with no continuing alerts.

As shown in FIG. 7A, received messages appear as an unopened envelope with a contact name or phone number if not in the user's contacts menu. A blue electric ‘message’ alert light located in the message center of the display blinks when unopened/incoming text messages appear on the screen. The blinking continues until the message or messages are opened. The third and last alert is the reading alert. It begins 3 seconds after opening a received or previously sent message. The alert message flashes once along with the upward blinking lights and arrows and vibrations for the first 1.5 seconds ending in the screen blanking out. Pushing any button brings the driver back to the screen and the alert begins again after 3 seconds. When the driver screens out of a message the screen returns to the main menu and the scrolling alert timings pick up where the reading alert left off. Received messages have the following options on the bottom of the screen: ERASE, REPLY and OPTIONS. The REPLY label is at the center bottom of the screen and enters a composition screen when selected. Reply activates when OK or SEND keys are pressed. Typing in this screen automatically starts the timing on the composition alert. The driver can only press SEND and OK or END during an alert which immediately screens the driver back to the main menu after the alert. OPTIONS has a FORWARD and REPLY WITH COPY selections. Reply and reply with copy is the same as entering a composition screen with the appropriate alert. The options, forward and erase menus activate the scrolling alert timing. The reading alert activates when opening any

messages.

All messages are automatically saved to the appropriate inbox or sent box of the connected cellular phone until erased. If maximum message capacity is reached by the cellular phone 16, an alert is flashed across the display screen 160 when additional messages are attempting to collect. The SHIFT key capitalizes letter characters and the FN key allows secondary symbols or numbers (symbols or number in the upper right corners of the keys 13) to be typed for every time its pressed. SEND and OK keys function in the same manner and allow for selection of anything highlighted by scrolling.

They also select the center bottom most option on any menu when pressed. CLEAR and END keys allow the user to screen out of any screen. Both keys function the same unless a message is being composed/edited. Then pressing the CLEAR key only backspaces and erases characters. The message bar 1169 is located on the far right side of the display screen occupying about a fifth of the screen's length. The menu depicts the following options: contacts, settings, new message, inbox, sent, and drafts. Inbox, sent and drafts have a number with parentheses around it representing how many messages are currently stored in each mailbox from the cellular phone's texting program. Messages saved automatically or manually are saved to the connected cellular phone's inbox, sent or drafts boxes. They can also be erased through the embodiment's

program.

Selecting contacts brings the user to a screen with a list of contact designations/names manually entered and/or downloaded from a cell phone. The screen contains a view option on the center bottom of the screen and an add contacts options located on the bottom of the screen. The view option shows a screen with the appropriate name and phone number selected from the

contact list. Add contacts option provides a screen to manually enter a name and phone number. Pressing the CONTACTS key on the left keypad brings the user directly to this screen. The settings menu contains the following selections: Bluetooth, vibration, lights, spell corrector, display settings and IM screen mode. The Bluetooth option has a selection which allows the user to set the embodiment to discoverable mode by hitting OK or SEND. The cellular phone to be connected can then remotely search for the device. The vibration option brings the user to a screen that allows the user to manipulate the vibration
strength incrementally from high to low. User may scroll to one or the other. Once the selection is made by hitting OK or SEND the vibration motors will activate for three seconds as a test. The lights selection allows the user to select
high to low settings incrementally for the yellow electric warning lights and arrows. Once the selections is made by hitting OK or SEND the lights' brightness will be changed accordingly. The spell corrector option allows the user to turn it on or off.

IM screen mode selection sets the device to an IM screen format. In other words, sent and received messages stacked on each other in order of the most recent to least recent message from the top to the bottom of the screen from and to the same individual. The same alerts apply. The scrolling alert occurs when viewing the stacked list. The reading and composition alerts are the same

except scrolling out (whether by saving a message, sending a message or screening out) returns you to the stacked messages with a new message option always at the top that can be activated by scrolling and selecting it. Only pressing END returns the user to the main menu from the stacked list. New messages from a texter outside the conversation appear as an unopened
envelope titled by name or number if unknown. Entering that message starts a new list of sent and received messages from that specific texter. Scrolling left or right returns you to the former conversation and is considered part of the scrolling alert.

The display settings selection has a character size and wall paper option. Character size can be set to normal or large. Large makes typed and read characters bigger than the normal set text. Wall paper shows a variety of different solid colors and allows the user to select one background color for the screens and menus.

The new message selection brings the user to a screen with numbered sectioned blank lines that allows the user to add the appropriate contact name or phone number from contacts and recent texts. One may also add a contact name or phone number manually. OK at the bottom center of the screen and add are the only two selections. Once SEND or OK is hit the display goes to a composition screen and the alert timing begins once typing starts. The inbox option brings the user to a list of partially shown previously received messages from the connected cellular phone with the appropriate designations whether name and/or just phone number, if not in the contact list, above them. Selecting SEND or OK opens a highlighted message and begins the reading alert. The screen's options and configuration are the same as a normal reading screen. An OK label is on the bottom center of the screen. Two other selections are also labeled on the bottom of the screen: options and erase. The options selection brings the user to a screen with the following selections: add to contacts, forward and reply.

The sent selection brings the user to a list of partially shown previously sent messages from the connected cellular phone 16 with the appropriate designations whether name and/or phone number, if unknown, above them. Pressing SEND or OK opens the highlighted message and begins the reading alert. The screen's options and configuration are the same as a normal reading screen.

OK is labeled on the center bottom of the screen with two selections options and erase on either side. Options has a menu with add to contacts, forward and reply selections.

The drafts selection brings the user to a list of partially shown previously saved messages with the appropriate designations whether name and/or phone number, if unknown, above them. Selecting SEND or OK activates the EDIT function which is labeled on the bottom of the screen. This opens the highlighted message and begins the composition alert timing when typing begins. The screen's options and configuration are the same as a normal composition screen. Two selections are also labeled on the bottom of the screen: options and erase. Options selection has add to contacts and send choices. Any remaining screens not described here conform to standard texting program ones. The embodiment has an automatic spell corrector with text acronym database (i.e., lol, brb, ttyl, etc.). The screen displays text in large print so that text messages may be easily viewed at a glance. A stud 36 in the center of the keypads aids the driver in key orientation without having to look at the pads. After a few uses a driver can text without looking at the keys and seldom at the screen. A sleep mode function allows batteries to rest and/or recharge. The device shuts down after a few minutes of non-use. Holding the END key down for 3 seconds turns the device off.

The night safe light buttons 34 illuminates their individual keypad when pressed. Pressing them an additional time, turns them off. Battery charge indicators have four increments of light that turn off as the charge falls by 25 percent. While being charged, the increments light in succession as each 25 percent of power is replenished. The hand units attach to a steering wheel's rim from the sides. The top of the hand units snap onto the steering wheel rim at the 2 and 10 o'clock positions. The bottom of the vibration housings form into clips located in the bottom center and have an attachment means such as a tightening screw with spokes adjacent to a pawl. Turning tightening screw 46 pushes the screw down fastening the hand units securely on to a steering wheel rim.

The display screen unit's steering wheel grip 76 attaches to the top center portion of a steering wheel's rim (see FIG. 3). Once the rim is inside the grip, the user may the tightening clamp 80 down until it is sufficiently braced against the steering wheel rim. Any attachment such as a screw could replace this clamp.

### Alternative Embodiments

Another alternative embodiment could be the original embodiment fully integrated into the steering wheel and/or the display screen into the dashboard. One other alternative might be having either a singular left or right handed hand unit (depending on users preferred hand) similar to the original embodiment with a standard vertical keypad consisting of individual keys

devoted to three letters and one number. The first most upper left hand key would only scroll through one number and a limited number of commonly used symbols. The keypad would also include shift, function, scrolling, contacts, clear,
send, end and space keys. Or it may have a touch screen pad with numerous keys for characters whether symbols, letter or numbers. The display screen and alerts would remain the same as the original embodiment.

Another embodiment may be the afore mentioned with an additional left or right hand unit with no keys but simply senses the drivers hand on it. If the hand unit does not, the display screen blanks until it senses the hand is back on it. Another possibility might be a wireless combination mic and earpiece that, when spoken into, remotely transmits and translates speech to text information to a text only display screen with vibrating hand units similar to the first embodiment. The vibration alert would warn the driver when they have been speaking too much in conjunction with light and message alerts similar to the first

embodiment. Finally, the original embodiment may have the outside frame alert lights and arrows represented as program generated graphics along the tops and sides of the actual screen that appear when an alert is activated. The top and
bottom bars would have check road written on them. All lights and arrows would blink appropriately in correspondence to the original embodiments described alerts. The blue message light would not exist in this configuration nor would the quick flash “CHECK ROAD” message before alerts.

Although shown in use with a car steering wheel the device 1 could be attached to the steering device for a boat, bicycle, motorcycle, tractor or riding mower for example.

### Advantages

The handgrip units 12 fasten safely to the steering wheel 10 with a combination of the driver, simultaneously, holding on to them and the steering wheel through the finger slots, the tightening screw 46 or clamp 146. The attached keypads 38 simulate a landscape/horizontal keypad cellular phone that avid texters typically use and can be physical keys or touch screen. This removes any required practice in using the embodiment. The keypads 38 on each hand unit 12 are easily viewable as they are high and in front of the driver keeping eyes close to windshield level. Because the keypads 38 are separated, the driver must have both hands on the wheel 10 in order to communicate and text. The privacy screen makes texting while a driver turns nearly impossible due to its ability to make on screen text less visible when not directly positioned in front of the driver.

Large type text is used for a quick glance at text messages. A privacy screen prevents passenger distraction indirectly aiding in road awareness. The broad length of the screen allows messages to not scroll as far down as typical cellular phone screens do to compose or read a message. The display screens' light alerts blink in an upward fashion compelling the user's eyes to follow the lights and look up from the screen at the road. This also allows the driver to have a more sweeping view of the screen while reading and corn posing so that they may notice the light alerts more readily. The driver can react faster by having the

display screen close to road level on the top of the steering wheel. Instead of looking to the side and/or down six to twelve inches at a cell phone screen the driver would only have to look up a couple inches to see the road. The display
screen and hand units will turn with the steering wheel making it both difficult to compose and/or read text messages helping prevent turning accidents. An automatic spell corrector fixes misspelled words and acronyms (lol, brb, ttyl, etc.) for less required concentration.

While the above description contains many specificities, these should not be construed as limitations on the

scope, but rather exemplification of one preferred embodiment thereof. Other variations on the preferred embodiment can include, but are not limited to: differently shaped, configuration and/or brightness of electric lights and/or arrows.
pauses between alert cues which may have variable durations hand units may connect remotely to the display screen by other means than a Bluetooth application (i.e. USB)

1. A communications device for use with an automotive steering wheel including;
a screen attached to a steering wheel; said screen including a first alert device;
a first hand unit attached to said steering wheel adjacent the left hand of the user;
a second hand unit attached to said steering wheel adjacent the right hand of said user;
wherein said first hand unit includes a first communications control and a second alert device;
wherein said second hand unit includes a second communications control and a third alert device;
such that when said user is driving and communicating the user receives an alert from said first alert on a regular basis and an alert from said second and third alerts on a variable basis.

2. The communications device of claim 1 wherein said first communications control includes a first alpha-numeric keyboard suitable for texting with the left thumb and said second communications control includes a second alpha-numeric keyboard suitable for texting with the right thumb wherein said first alpha-numeric keyboard includes some but not all of the letters of the alphabet and said second alpha-numeric keyboard includes at least those letters of the alphabet not on said first alpha-numeric keyboard.

3. The communications device of claim 1 wherein said first alert device includes flashing arrows and a message on said screen directing the driver to look up at the road.

4. The communications device of claim 1 wherein said second alert includes a first vibratory motor in said first hand unit and said third alert includes a second vibratory motor in said second hand control and said communications device includes a controller to send an alert signal to said first and second vibratory motors, said alert signal being triggered by some but not all instances of text communications.

5. The communications device of claim 1 wherein said first alert is triggered automatically after each instance of entering texting communication information into said first or second communications controls and said second and third alerts are triggered by some but not all instances of said first alert.

6. The communications device of claim 5 wherein said text information includes at least one of texting, scrolling and composing.

7. A communication device for use with a vehicle steering device including;
a screen attached to a steering device using a first attachment;
a first hand unit having a first alpha-numeric keyboard and attached to said steering device adjacent the left hand of the user using a second attachment;
a second hand unit having a second alpha-numeric keyboard and attached to said steering device adjacent the right hand of the user using a third attachment;
wherein said first, second and third attachments can be released from said steering device to thereby remove the screen and first and second hand units from said steering device and
wherein said first and second hand units can be attached to said screen for portability.

8. The communication device of claim 7 wherein said first hand unit includes a grip portion wrapped around a portion of said steering device such that a user can simultaneously grip said steering device and said grip portion with a single hand.

9. The communication device of claim 7 wherein said first keyboard and said second keyboard form a complete qwerty keyboard suitable for texting.

10. The communications device of claim 7 wherein said screen, first keyboard and second keyboard are in wireless communication to a cell phone in said vehicle.

11. The communications device of claim 9 wherein said screen includes a controller generated alert triggered by texting, scrolling or composing using said first or second keyboard.

12. The communications device of claim 9 wherein said first and second hand units include a second alert triggered by texting, sometimes by scrolling and randomly by composing.

13. The communications device of claim 9 wherein said steering device is a steering wheel.

14. A communications device for use with an vehicle steering device including;
a screen attached to a steering device; said screen including a first alert device;
a first hand unit attached to said steering device;
a second hand unit attached to said steering device;
wherein said first hand unit includes a first communications control and a second alert device;
wherein said second hand unit includes a third alert device;
such that when said user is driving and communicating the user receives an alert from said first alert device on a regular basis and an alert from said second and third alerts on a variable basis.

15. The communications device of claim 14 wherein said steering device is a steering wheel.

16. The communications device of claim 15 wherein said first communications control includes a first alpha-numeric keyboard suitable for texting with the left thumb and a second communications control includes a second alpha-numeric keyboard suitable for texting with the right thumb wherein said first alpha-numeric keyboard includes some but not all of the letters of the alphabet and said second alpha-numeric keyboard includes at least those letters of the alphabet not on said first alpha-numeric keyboard.

17. The communications device of claim 15 wherein said screen, first keyboard and second keyboard are in wireless communication to a cell phone in said vehicle.

18. The communications device of claim 15 wherein said first alert device includes flashing arrows and a message on said screen directing the driver to check the road.
